(19) United States
(12) Patent Application Publication
(10) Pub. No.: US 2026/0304508 A1
(43) Pub. Date: Oct. 1, 2026

(54) METHODS AND SYSTEMS FOR MANAGING NON-ACCESS STRATUM (NAS) SIGNALLING IN A WIRELESS COMMUNICATION SYSTEM

(71) Applicant: Samsung Electronics Co., Ltd., Suwon-si (KR)

(72) Inventors: Arvind RAMAMURTHY, Bangalore (IN); Neha SHARMA, Bangalore (IN); Jagadeesh GANDITOKA, Bangalore (IN); Gaorav Kumar GUPTA, Bangalore (IN); Arijit SEN, Bangalore (IN)

(21) Appl. No.: 19/575,482

(22) Filed: Mar. 23, 2026

Related U.S. Application Data
(63) Continuation of application No. PCT/KR2026/003928, filed on Mar. 11, 2026.

(30) Foreign Application Priority Data
Mar. 28, 2025 (IN) 202541030069
Feb. 19, 2026 (IN) 202541030069

(51) Int. Cl. H04W 76/10; H04W 76/30; H04W 80/06

(52) U.S. Cl. CPC H04W 76/10; H04W 76/30; H04W 80/06

(57) ABSTRACT

Methods and systems for managing non-access stratum (NAS) signalling in a wireless communication system are provided. A method includes receiving, by a radio access network (RAN) node, a request for connection establishment from a user equipment (UE). The request comprises an indication for using NAS-over-internet protocol (IP). The method includes assigning, by the RAN node, an IP address to the UE based on the request. The method further includes establishing, by the RAN node, an IP connection between the UE and a network-side interworking network function, over a wireless communication channel.

### CROSS-REFERENCE TO RELATED APPLICATIONS

This application is a continuation of International Application No. PCT/KR2026/003928 designating the United States, filed on Mar. 11, 2026, in the Korean Ministry of Intellectual Property Receiving Office and claiming priority to Indian Provisional Patent Application No. 2025410030069, filed on Mar. 28, 2025, and Indian Complete Patent Application No. 202541030069, filed on Feb. 19, 2026, in the Indian Patent Office, the disclosures of each of which are incorporated by reference herein in their entireties.

### BACKGROUND

### Field

The disclosure relates to wireless communication, and for example relates to systems and methods for managing Non-Access Stratum (NAS) signalling in a wireless communication system.

### Description of Related Art

Wireless communication systems defined by the third generation partnership project (3GPP), employ a layered protocol architecture to manage communication between user equipment and core network functions. The non-access stratum (NAS) represents a functional layer in this protocol stack that handles mobility management, session management, and other control plane functions between user equipment and core network entities. In existing communication systems, including long term evolution (LTE) and fifth generation (5G) networks, NAS messages are transmitted over a control plane path through radio access network nodes to reach core network functions such as access and mobility management function (AMF). The AMF serves as a centralized network function that receives NAS messages from user equipment and routes these messages to appropriate network functions for processing. This architecture has been deployed in current mobile networks to provide registration, authentication, and session management services to user equipment.

The current approach to NAS message transport presents several challenges for network operators and equipment manufacturers. For example, when NAS messages are sent over the control plane to a single common network function, such as the AMF, the complexity at this node increases. For example, the AMF handles routing to different network functions and maintains awareness of features supported by various network entities, thereby increasing the complexity. Further, as new network functions are introduced in the network, legacy network functions may be impacted, requiring modifications across multiple nodes to support new services. The indication of feature support between user equipment (UE) and network entities requires the inclusion of information elements (IEs) in registration messages. Such inclusion increases the complexity of NAS messages and complicates the selection of network functions based on supported features. Additionally, the radio access network performs processing and forwarding of NAS protocol data units, contributing to the processing load at the access network.

Further, network operators have varying requirements for service deployment, and it may not be practical for all operators to deploy all network functions or support all network features. The current architecture may not readily accommodate the flexible deployment of selected network functions. When new features are introduced, the adoption rate may be affected by the availability of user equipment supporting those features. The centralized handling of NAS signalling through a single network function may limit the ability to dynamically deploy new services without affecting multiple network entities in the signalling path.

Hence, there is a need for improved techniques that address the above-mentioned and other related problems.

### SUMMARY

According to an example embodiment of the disclosure, disclosed herein is a method for establishing non-access stratum (NAS) signalling in a wireless communication system. The method includes: receiving, at a radio access network (RAN) node, a request for connection establishment from a user equipment (UE), wherein the request may comprise an indication for using NAS-over-internet protocol (IP; assigning, by the RAN node, an IP address to the UE based on the request; and establishing, by the RAN node, an IP connection between the UE and a network-side interworking network function, over a wireless communication channel.

According to an example embodiment of the disclosure, a method for switching non-access stratum (NAS) signalling from a control plane to a data plane in a wireless communication system is disclosed. The method includes: transmitting, by a radio access network (RAN) node, a registration request to an access and mobility management Function (AMF), wherein the registration request corresponds to a radio resource control (RRC) connection request received from a user equipment (UE; receiving, by the RAN node, a registration accept message from the AMF, wherein the registration accept message comprises an internet protocol (IP) address for the UE and an IP address of a network-side interworking network function; and establishing, by the RAN node, a connection, with an indicator, between the UE and the network-side interworking network function in response to the Registration Accept message, wherein the indicator includes NASoverIP indicating subsequent NAS signalling to be performed over the data plane.

According to an example embodiment of the disclosure, a method for establishing a non-access stratum message (NAS) signalling in a wireless communication system using a user equipment (UE) is disclosed. The method includes: receiving configuration information based on the NAS signalling, wherein the configuration information is indicative of a set of NAS services carried over a control plane (CP) path and a set of NAS services carried over an internet protocol (IP) path; and operating, over the CP path and IP path based on the configuration information, wherein the CP path and IP path are maintained in an active state by radio access network (RAN) node for operation.

According to an example embodiment, the disclosure provides an apparatus for establishing non-access stratum (NAS) signalling in a wireless communication system. The apparatus comprises: a memory and at least one processor, comprising processing circuitry, coupled to the memory, wherein at least one processor, individually and/or collectively, is configured to cause the apparatus to: receive a request for connection establishment from a user equipment (UE), wherein the request comprises an indication for using NAS-over-internet protocol (IP); assign an IP address to the UE based on the request; and establish an IP connection between the UE and a network-side interworking network function, over a wireless communication channel.

According to an example embodiment, an apparatus for switching non-access stratum (NAS) signalling from a control plane to a data plane in a wireless communication system is provided. The apparatus comprises: a memory and at least one processor, comprising processing circuitry, coupled to the memory, wherein at least one processor, individually and/or collectively, is configured to cause the apparatus to: transmit a registration request to an access and mobility management function (AMF), wherein the registration request corresponds to a radio resource control (RRC) connection request received from a user equipment (UE); receive a registration accept message from the AMF, wherein the registration accept message comprises an internet protocol (IP) address for the UE and an IP address of a network-side interworking network function; and establish, in response to the registration accept message, a connection with an indicator between the UE and the network-side interworking network function, wherein the indicator includes NAS-over-internet protocol (IP) indicating subsequent NAS signalling to be performed over the data plane.

According to an example embodiment, an apparatus for establishing non-access stratum (NAS) message signalling in a wireless communication system using a user equipment (UE) is disclosed. The apparatus comprises: a memory and at least one processor, comprising processing circuitry, coupled to the memory, wherein at least one processor, individually and/or collectively, is configured to cause the apparatus to: receive configuration information based on the NAS signalling, wherein the configuration information is indicative of a set of NAS services carried over a control plane (CP) path and a set of NAS services carried over an internet protocol (IP) path; and operate over the CP path and IP path based on the configuration information, wherein the CP path and IP path are maintained in an active state by radio access network (RAN) node for operation.

To further clarify the advantages and features of the disclosure, a more detailed description will be rendered by reference to various example embodiments thereof, which are illustrated in the appended drawings. It is appreciated that these drawings depict example embodiments of the disclosure and are therefore not to be considered limiting its scope. The disclosure will be described and explained with additional specificity and detail with the accompanying drawings.

### BRIEF DESCRIPTION OF THE DRAWINGS

These and other features, aspects, and advantages of certain embodiments of the disclosure will be more apparent from the following detailed description, taken in conjunction with the accompanying drawings in which like characters represent like parts throughout the drawings, and in which:

FIG. 1 is a diagram illustrating an example wireless communication system configured to support non-access stratum signalling over Internet Protocol, according to various example embodiments;

FIG. 2 is a block diagram illustrating an example configuration of an apparatus for managing non-access stratum (NAS) signalling in the wireless communication system, according to various example embodiments;

FIG. 3 is a signal flow diagram illustrating example transporting non-access stratum messages over an Internet Protocol connection, according to various example embodiments;

FIG. 4 is a signal flow diagram illustrating example switching from control plane to the Internet Protocol for non-access stratum message transfer, according to various example embodiments;

FIG. 5 is a signal flow diagram illustrating example switching non-access stratum message transfer from Internet Protocol to control plane, according to various example embodiments;

FIG. 6 is a signal flow diagram illustrating an example network-initiated internet protocol switch procedure, according to various example embodiments;

FIGS. 7A and 7B are diagrams illustrating example network architectures for the non-access stratum over Internet Protocol communication, according to various embodiments;

FIG. 7C is a diagram illustrating an example network architecture using an interworking function as an anchor point, according to various example embodiments;

FIG. 7D is a diagram illustrating an example network architecture using a user plane function as the anchor point, according to various example embodiments;

FIG. 7E is a diagram illustrating an example network architecture using a new network function as the anchor point, according to various example embodiments;

FIG. 8A is a diagram illustrating an example protocol stack architecture depicting configurations for non-access stratum layer placement, according to the prior art;

FIGS. 8B and 8C are diagrams illustrating example protocol stack architectures depicting example configurations for non-access stratum layer placement, according to various example embodiments;

FIG. 9 is a flowchart illustrating an example method for establishing NAS signalling in the wireless communication system, according to various example embodiments;

FIG. 10 is a flowchart illustrating an example method switching NAS signalling from a control plane to a data plane in the wireless communication system, according to various example embodiments;

FIG. 11 is a block diagram illustrating an example configuration of an apparatus for establishing NAS message signalling in the wireless communication system using a user equipment (UE), according to various example embodiments;; and

FIG. 12 is a flowchart illustrating an example method for establishing NAS signalling in the wireless communication system using a user equipment (UE), according to various example embodiments.

Further, skilled artisans will appreciate that elements in the drawings are illustrated for simplicity and may not have necessarily been drawn to scale. For example, the flowcharts illustrate the method in terms of operations involved to help to improve understanding of aspects of the disclosure. Furthermore, in terms of the construction of the device, one or more components of the device may have been represented in the drawings by conventional symbols, and the drawings may show details that are pertinent to understanding the disclosure so as not to obscure the drawings with details that will be readily apparent to those of ordinary skill in the art having the benefit of the description herein.

### DETAILED DESCRIPTION

For the purpose of promoting an understanding of the principles of the disclosure, reference will now be made to the various example embodiments, and specific language will be used to describe the same. It will nevertheless be understood that no limitation of the scope of the disclosure is thereby intended, such alterations and further modifications in the illustrated system, and such further applications of the principles of the disclosure as illustrated therein, being contemplated as would normally occur to one skilled in the art to which the disclosure relates.

It will be understood by those skilled in the art that the foregoing general description and the following detailed description are explanatory of the disclosure and are not intended to be restrictive thereof.

Whether or not a certain feature or element was limited to being used only once, it may still be referred to as “one or more features” or “one or more elements,” “at least one feature,” or “at least one element.” Furthermore, the use of the terms “one or more” or “at least one” feature or element does not preclude there being none of that feature or element, unless otherwise specified by limiting language, including, but not limited to, “there needs to be one or more…” or “one or more elements are required.”

Reference is made herein to some “embodiments.” It should be understood that an embodiment is an example of a possible implementation of any features and/or elements of the disclosure. Various embodiments have been described for the purpose of explaining one or more of the potential ways in which the specific features and/or elements of the disclosure fulfill the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Any features and/or elements described in the context of separate embodiments may alternatively be realized as existing together in the context of a single embodiment.

Any particular and all details set forth herein are used in the context of various embodiments and therefore should not necessarily be taken as limiting factors to the disclosure.

The terms “comprises”, “comprising”, or any other variations thereof, are intended to cover a non-exclusive inclusion, such that a process or method that comprises a list of operations does not include only those operations but may include other operations not expressly listed or inherent to such process or method. Similarly, one or more devices or sub-systems or elements or structures or components preceded by “comprises... a” does not, without more constraints, preclude the existence of other devices or other sub-systems or other elements or other structures or other components or additional devices or additional sub-systems or additional elements or additional structures or additional components.

The term “couple” and the derivatives thereof refer to any direct or indirect communication between two or more elements, whether or not those elements are in physical contact with each other. The terms “transmit”, “receive”, and “communicate”, as well as the derivatives thereof, encompass both direct and indirect communication. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, may refer, for example, to different combinations of one or more of the listed items may be used, and one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” may refer, for example, to one or more. Accordingly, the set of items may be a single item or a collection of two or more items.

Moreover, multiple functions described below may be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as read only memory (ROM), random access memory (RAM), a hard disk drive, a compact disc (CD), a digital video disc (DVD), or any other type of memory. A non-transitory computer-readable medium includes media where data may be permanently stored and media where data may be stored and later overwritten, such as a rewritable optical disc or an erasable memory device.

Common reference numerals may be used throughout the figures to indicate similar features.

In an embodiment, the disclosure provides techniques for transporting non-access stratum signalling over internet protocol in next-generation mobile networks, including fifth generation (5G) and sixth generation (6G) deployments. The disclosed techniques enable flexible service deployment by allowing network operators to introduce new services without modifying multiple network functions. Further, the disclosed techniques reduce the complexity at individual network nodes by enabling direct communication between a user equipment (UE) and relevant network functions over the data plane.

The following terminology may be used throughout this disclosure:

Non-access stratum (NAS) refers to the functional layer in the protocol stack between a UE and a core network that handles mobility management, session management, and other control plane functions. NAS messages include registration requests, service requests, and other signalling messages exchanged between the user equipment and core network functions.

Radio access network (RAN) refers to the portion of a mobile network that connects user equipment to the core network through radio communication. A RAN node includes base stations such as gNodeB (gNB) in 5G networks that provide wireless connectivity to user equipment.

Internet protocol (IP) refers to the network layer protocol used for routing packets across networks. IP addresses identify endpoints in the network and enable data transmission between devices.

Access and mobility management function (AMF) refers to a core network function that handles registration management, connection management, mobility management, and access authentication and authorization for user equipment.

Non-third generation partnership project (3GPP) interworking function (N3IWF) refers to a network function that enables user equipment to connect to a 5G core network through untrusted non-3GPP access networks. The N3IWF terminates IPsec tunnels from user equipment and interfaces with core network functions.

Trusted non-3GPP gateway function (TNGF) refers to a network function that enables user equipment to connect to a 5G core network through trusted non-3GPP access networks.

User plane function (UPF) refers to a core network function that handles user plane packet processing, including packet routing, forwarding, and inspection.

Session management function (SMF) refers to a core network function that handles session establishment, modification, and release, as well as IP address allocation for user equipment.

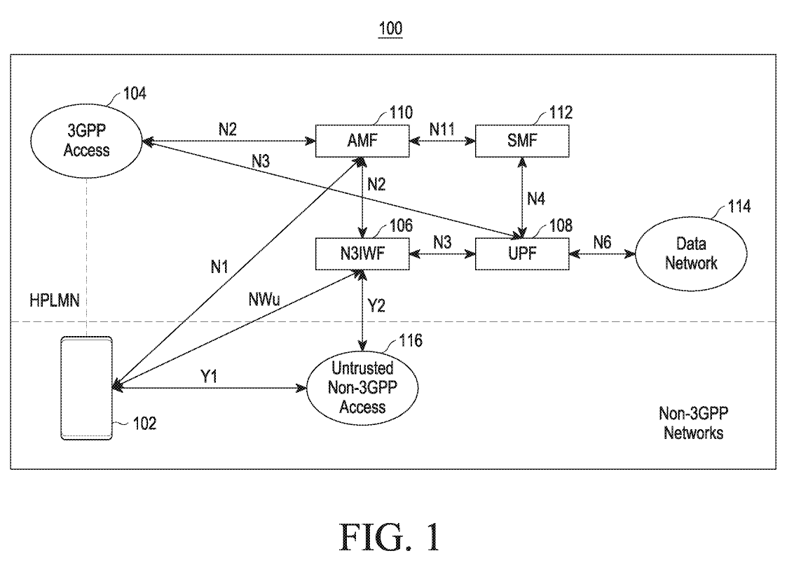

FIG. 1 is a diagram illustrating an example wireless communication system 100 configured to support non-access stratum signalling over internet protocol (IP), according to various example embodiments. As shown, the wireless communication system 100 may include a UE 102, a 3GPP access network 104, an interworking function 106, a UPF 108, an AMF 110, an SMF 112, a new network function 116, and untrusted non-3GPP access network 116.

As shown, the wireless communication system 100 is divided into two domains. An upper portion of the wireless communication system 100 represents a home public land mobile network (HPLMN) containing core network functions. A lower portion of the wireless communication system 100 represents non-3GPP networks. The HPLMN domain may include the interworking function 106, the UPF 108, the AMF 110 and the SMF 112. The non-3GPP network domain encompasses untrusted non-3GPP access 116 networks through which the UE 102 connects to the core network via the interworking function 106.

The 3GPP access network 104 is shown in two locations within the wireless communication system 100 and corresponds to a RAN node in the context of 3GPP access. The 3GPP access network 104 (hereinafter referred to as "RAN node 104") is positioned in an upper left portion of the wireless communication system 100 and provides radio access connectivity for the UE 102 to the core network. The RAN node 104, such as gNB base stations, establishes wireless communication channels with the UE 102. The RAN node 104 performs the RAN functions described herein, including receiving connection requests from the UE 102, allocating IP addresses, and establishing IP connections to the interworking function 106. The untrusted non-3GPP access network 116 is positioned in the lower right portion of the wireless communication system 100 and provides an alternative access path for the UE 102 to reach the core network through the interworking function 106.

The UE 102 may be a wireless device configured to communicate with the 3GPP access network 104 and to transmit and receive NAS messages. In accordance with the disclosure, the UE 102 connects to the 3GPP access network 104 via an N1 interface. The N1 interface carries NAS signalling between the UE 102 and the AMF 110 through the 3GPP access network 104. The UE 102 also connects to the untrusted non-3GPP access network 116 via a Y1 interface. The Y1 interface provides connectivity between the UE 102 and the untrusted non-3GPP access network 116 for non-3GPP access scenarios.

The 3GPP access network 104, functioning as the RAN node, connects to the AMF 110 via an N2 interface. The N2 interface carries control plane signalling between The RAN node 104 (e.g., the RAN node such as gNB 301 shown in subsequent figures) and the AMF 110. In various embodiments of the disclosure, the 3GPP access network 104 also connects to the interworking function 106 via an N3 interface. The N3 interface enables user plane data transfer between the RAN node 104 and the interworking function 106 when NAS messages are transported over the data plane in accordance with the disclosed method.

The untrusted non-3GPP access network 116 connects to the interworking function 106 via a Y2 interface. The Y2 interface provides connectivity between the untrusted non-3GPP access network 116 and the interworking function 106 for routing traffic from non-3GPP access paths.

The interworking function 106 is positioned centrally within the HPLMN and, in accordance with the disclosure, may serve as an anchor point for NAS signalling transported over the data plane. The interworking function 106 may comprise a non-3GPP interworking function or a trusted non-3GPP gateway function. The UE 102 connects to the interworking function 106 via an NWu interface for non-3GPP access scenarios. The NWu interface carries IPsec-protected traffic between the UE 102 and the interworking function 106. The interworking function 106 connects to the AMF 110 via an N2 interface. This N2 interface enables the interworking function 106 to forward NAS messages received from the UE 102 to the AMF 110 for processing. The interworking function 106 also connects to the UPF 108 via an N3 interface for user plane data transfer.

The AMF for the UE 102. The AMF 110 connects to the SMF 112 via an N11 interface. The N11 interface carries session management signalling between the AMF 110 and the SMF 112.

The SMF 112 manages session establishment, modification, and release for the UE 102. The SMF 112 connects to the UPF 108 via an N4 interface. The N4 interface enables the SMF 112 to configure the UPF 108 for packet processing and routing.

The UPF 108 handles user plane packet processing, including packet routing and forwarding. The UPF 108 connects to the new network function 116 via an N6 interface. The N6 interface provides connectivity between the user plane function 108 and external data networks represented by the new network function 116.

In accordance with various example embodiments of the disclosure, the wireless communication system 100 enables the UE 102 to transport NAS messages over the data plane by establishing connections through the interworking function 106. When the UE 102 indicates a preference for NAS-over-IP, the 3GPP access network 104 (e.g., the RAN node, such as the RAN node 104) allocates an IP address to the UE 102 and establishes a data bearer for NAS message transport as described throughout the disclosure. The UE 102 encapsulates NAS messages into IP packets and transmits the IP packets to the interworking function 106 over the data bearer. The interworking function 106 receives the IP-encapsulated NAS messages and forwards the NAS messages to the AMF 110 via the N2 interface.

In accordance with the disclosure, the wireless communication system 100 achieves flexible service deployment and reduced complexity at individual network nodes by configuring the UE 102 to send a connection request with a NAS-over-IP indication to the 3GPP access network 104. The 3GPP access network 104 allocates an IP address and establishes an IP connection to the interworking function 106. Thus, the disclosure enables NAS signalling to flow through the N3 interface to the interworking function 106 and subsequently to the AMF 110 via the N2 interface, allowing network operators to introduce new services without modifying multiple network functions.

Accordingly, the disclosed techniques support both 3GPP access and non-3GPP access paths for delivering NAS signalling messages to the core network functions, enabling flexible deployment of network services without modifying multiple network functions.

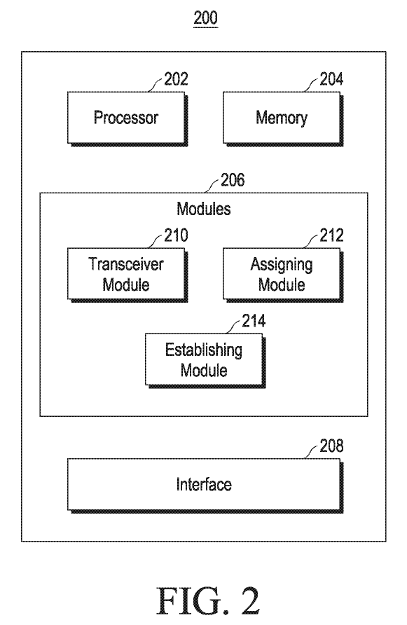

FIG. 2 is a block diagram illustrating an example configuration of an apparatus for managing NAS signalling in the wireless communication system 100, according to various example embodiments. In an embodiment, the apparatus 200 may correspond to the RAN node 104. It should be noted that FIGS. 1 and 2 have been explained in conjunction with each other for the sake of brevity of the disclosure.

The apparatus 200 may include one or more processors (e.g., including processing circuitry) 202 (hereinafter referred to as the processor 202), a memory 204, one or more modules (e.g., including various circuitry and/or executable program instructions) 206, and a communication interface (e.g., including communication circuitry) 208. The one or more processors 202 may be operatively coupled to the memory 204, the modules 206, and the communication interface 208.

In an embodiment, the processor 202 may include at least one data processor for executing processes in a virtual storage area network. The processor 202 may include specialized processing units such as integrated system (bus) controllers, memory management control units, floating point units, graphics processing units, digital signal processing units, etc. In an embodiment, the processor 202 may include a central processing unit (CPU), a graphics processing unit (GPU), or both. The processor 202 may be one or more general processors, digital signal processors (DSPs), application-specific integrated circuits, field-programmable gate arrays (FPGAs), servers, networks, digital circuits, analog circuits, combinations thereof, or other now known or later developed devices for analyzing and processing data. The processor 202 may execute a software program, such as code generated manually (e.g., programmed), to perform the desired operation. The processor 202 may implement various techniques, such as, but not limited to, image processing, data extraction, artificial intelligence (AI), machine learning (ML), deep learning (DL), and so forth, to achieve the desired objective. Thus, the processor 202 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited /disclosed functions, e.g., in a distributed manner. At least one processor may execute program instructions to achieve or perform various functions.

In an embodiment, the processor 202 may be configured to perform the functions of the apparatus 200/The RAN node 104.

The processor 202 may be disposed in communication with one or more input/output (I/O) devices, such as the UE 102, via the communication interface 208. The interface 208 may employ communication code-division multiple access (CDMA), high-speed packet access (HSPA+), global system for mobile communications (GSM), long-term evolution (LTE), 5G, sixth generation (6G), WiMax, or the like, etc.

In an embodiment, the processor 202 may be disposed in communication with a communication network via a network interface. In an embodiment, the network interface may be the communication interface 208. The network interface may connect to the communication network to enable connection of the apparatus 200 with the outside environment and/or device/system. The network interface may employ connection protocols, including, without limitation, direct connect, ethernet (e.g., twisted pair 10/100/1000 Base T), transmission control protocol/internet protocol (TCP/IP), token ring, IEEE 802.11/b/g/n/x, etc. The communication network may include, without limitation, a direct interconnection, local area network (LAN), wide area network (WAN), wireless network (e.g., using wireless application protocol (WAP)), the internet, etc. Using the network interface and the communication network, the apparatus 200 may communicate with other devices. The network interface may employ connection protocols including, but not limited to, direct connect, ethernet (e.g., twisted pair 10/100/1000 Base T), TCP/IP, token ring, IEEE 802.11/b/g/n/x, etc.

The memory 204 may be communicatively coupled to the processor 202. The memory 204 may be configured to store data and instructions executable by the processor 202. In an embodiment, the memory 204 may communicate via a bus within the apparatus 200. The memory 204 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 204 may include a cache or random-access memory for the processor 202. The memory 204 may be separate from the processor 202, such as a cache memory of a processor, the system memory, or other memory. The memory 204 may be an external storage device or database for storing data. The memory 204 may be operable to store instructions executable by the processor 202. The functions, acts, or tasks illustrated in the figures or described may be performed by the programmed processor 202 for executing the instructions stored in the memory 204. The functions, acts, or tasks are independent of the particular type of instruction set, storage media, processor, or processing strategy, and may be performed by software, hardware, integrated circuits, firmware, micro-code, and the like, operating alone or in combination. Processing strategies may include multiprocessing, multitasking, parallel processing, and the like. The memory 204 may further include a database to store the data. Further, the memory 204 may include an operating system for performing one or more tasks of the apparatus 200, as performed by a generic operating system in the communications domain.

For the sake of brevity, the architecture and standard operations of the processor 202 and the memory 204 are not discussed in detail. In an embodiment, the memory 204 may be configured to store the information as required by the processor 202 to perform the techniques described herein.

The modules 206, amongst other things, may include routines, programs, objects, components, data structures, etc., which perform particular tasks or implement data types. The modules 206 may also be implemented as signal processor(s), state machine(s), logic circuitries, and/or any other device or component that manipulates signals based on operational instructions. The modules 206 may be configured to one or more operations of the apparatus 200 and/or the processor 202.

The modules 206 can be implemented in hardware, instructions executed by a processing unit, or by a combination thereof. The processing unit can comprise a computer, the processor 202, a state machine, a logic array, or any other suitable devices capable of processing instructions. The processing unit can be a general-purpose processor that executes instructions to cause the general-purpose processor to perform the required tasks, or the processing unit can be dedicated to performing the required functions. In an embodiment of the disclosure, the modules 206 may be machine-readable instructions (software) that, when executed by a processor/processing unit, perform any of the described functionalities. Furthermore, the data serves, amongst other things, as a repository for storing data processed, received, and generated by one or more of the modules. The modules 206 may include a transceiver module 210, an assigning module 212, and an establishing module 214.

In an embodiment, the apparatus 200 may be configured to establish NAS signalling in the wireless communication system 100. Accordingly, the transceiver module 210 may be configured to receive a request for connection establishment from the UE 102. In an embodiment, the transceiver module 210 may receive the request via the communication interface 208. In an embodiment, the request may comprise an indication for using NAS-over-Internet Protocol. In an embodiment, the request may be a radio resource control (RRC) connection request. The assigning module 212 may be configured to assign an IP address to the UE 102 based on the request. The establishing module 214 may then be configured to establish an IP connection between the UE 102 and a network-side interworking network function over a wireless communication channel. For example, let us assume that the UE 102, such as a smartphone, powers on and sends the request for connection establishment to the RAN node 104, such as a gNB with a NAS-over-IP flag set to true. Accordingly, the request indicates that the smartphone prefers IP-based NAS transport. The assigning module 212 processes this request and assigns an IP address to the smartphone based on the request, storing the allocation information in the memory 204. For instance, the assigning module 212 allocates IP address 10.0.0.50 from an IP pool maintained in the memory 204 and assigns it to the smartphone. The establishing module 214 then establishes, via the communication interface 208, an IP connection between the smartphone and a network-side interworking network function over the wireless communication channel. For example, the gNB establishes a data radio bearer and configures a tunnel to the N3IWF, enabling the smartphone to send IP-encapsulated NAS messages through the data plane. This approach offers significant advantages: it reduces signaling latency by eliminating repeated control plane setup, supports flexible service deployment, and minimizes and/or reduces processing load on the RAN node by handling NAS messages as IP traffic rather than control-plane signaling.

In an embodiment, the transceiver module 210 may transmit IP packets to the network-side interworking network function for delivery to a core-network function mobility management entity. The IP packets may correspond to encapsulated NAS messages using an internet-protocol based transport selected from a group including transmission control protocol (TCP), hypertext transfer protocol (HTTP), and quick UDP internet connections (QUIC). For instance, consider a smartphone initiating a registration procedure. The smartphone encapsulates a NAS registration request into a TCP packet and sends the TCP packet through the established IP connection to the N3IWF. Upon receiving the TCP packet, the N3IWF extracts the NAS message and forwards the NAS message to the AMF 110 for processing. This approach enables NAS signaling to occur over the data plane using IP-based transport, reducing reliance on traditional control plane signaling and improving flexibility for network deployments.

In an embodiment, the transceiver module 210 may continue to transmit the IP packets to the network-side interworking network function until the IP connection between the UE 102 and the network-side interworking network function is disconnected. This design ensures persistent NAS signaling without requiring repeated control plane setup procedures. For example, once a smartphone establishes an IP connection to the N3IWF during initial registration, the smartphone can continue sending NAS messages, such as service requests or mobility updates, over the same IP path until the IP bearer is released. Similarly, in a connected vehicle scenario, the UE 102 may transmit NAS messages for session updates or policy changes through an IP tunnel to the UPF acting as an anchor point. This uninterrupted communication persists until the IP connection is terminated due to events like UE power-off, network-triggered disconnection, or handover to a different access technology. By leveraging this approach, the disclosure achieves always-on NAS connectivity, reducing signaling latency and eliminating the need for repeated service request procedures.

In an embodiment, the IP address assigned by the RAN node 104 may be retained by the UE102 until another IP address is allocated by the RAN node 104. For example, the smartphone retains IP address 10.0.0.50 throughout its session and across multiple NAS procedures until the gNB allocates a new IP address during a subsequent connection establishment.

In an embodiment, the apparatus 200 may be configured to switch the NAS signalling from a control plane to a data plane. Accordingly, the transceiver module 210 may be configured to transmit a registration request to the AMF 110. In an embodiment, the transceiver module 210 may transmit the registration request via the communication interface 208. In an embodiment, the registration request may correspond to the RRC connection request received from the UE 102. For example, a UE 102, such as a tablet device, initially registers via a control plane. Accordingly, the RAN node 104, such as the gNB, forwards the registration request to the AMF 110. The transceiver module 210 may be further configured to receive a registration accept message from the AMF 110. In an embodiment, the transceiver module 210 may receive the registration request via the communication interface 208. In an embodiment, the registration accept message may include an IP address for the UE 102 and an IP address of the network-side interworking network function. For example, the AMF 110 responds with a registration accept containing IP address 192.168.1.100 for the tablet device and IP address 192.168.1.1 for the N3IWF. The transceiver module 210 may store these addresses in the memory 204.

In an embodiment, the establishing module 214 may be configured to establish a connection with an indicator between the UE 102 and the network-side interworking network function. In an embodiment, the establishing module 214 may be configured to establish the connection in response to the reception of the registration accept message. In an embodiment, the indicator may be NASoverIP, indicating that subsequent NAS signalling is to be performed over the data plane. For example, when the tablet device completes registration, the gNB sends an RRC connection release message with NASoverIP set to 1. This triggers the tablet to switch all future NAS messages to the IP-based data path through the N3IWF. This approach provides several advantages. Accordingly, the disclosure enables a seamless transition from control plane signaling to data plane signaling without service interruption. The disclosure reduces signaling latency by eliminating repeated control plane procedures. The disclosure further improves network efficiency by handling NAS messages as IP traffic. The disclosure supports flexible deployment of new services without impacting legacy network functions, which enhances scalability and reduces complexity for operators.

In an embodiment, the network-side interworking network function is selected from a group including N3IWF, TNGF, UPF enhanced to anchor NAS signalling, and a new network function configured to process NAS messages over IP transport. For example, in an enterprise deployment, the tablet device may be directed to connect to the UPF enhanced to anchor NAS signalling rather than the N3IWF. In an embodiment, the IP address provided in the registration accept message may be retained by the UE 102 until another IP address is allocated by the RAN node 104. For example, in an enterprise deployment scenario, the tablet device may be directed to connect to an enhanced UPF instead of the N3IWF to optimize/improve performance and reduce dependency on traditional interworking functions. Once the registration accept message is received, the UE 102 retains the assigned IP address, such as 192.168.1.100, for all subsequent NAS signaling over the data plane until a new IP address is allocated by the RAN node 104. This approach enables flexible deployment by allowing operators to choose the most suitable anchor point for NAS signaling and supports scalability for advanced services. This approach further reduces signaling complexity by maintaining persistent IP-based connectivity. Additionally, retaining the IP address across multiple NAS procedures minimizes and/or reduces overhead and improves session continuity, resulting in lower latency and better user experience.

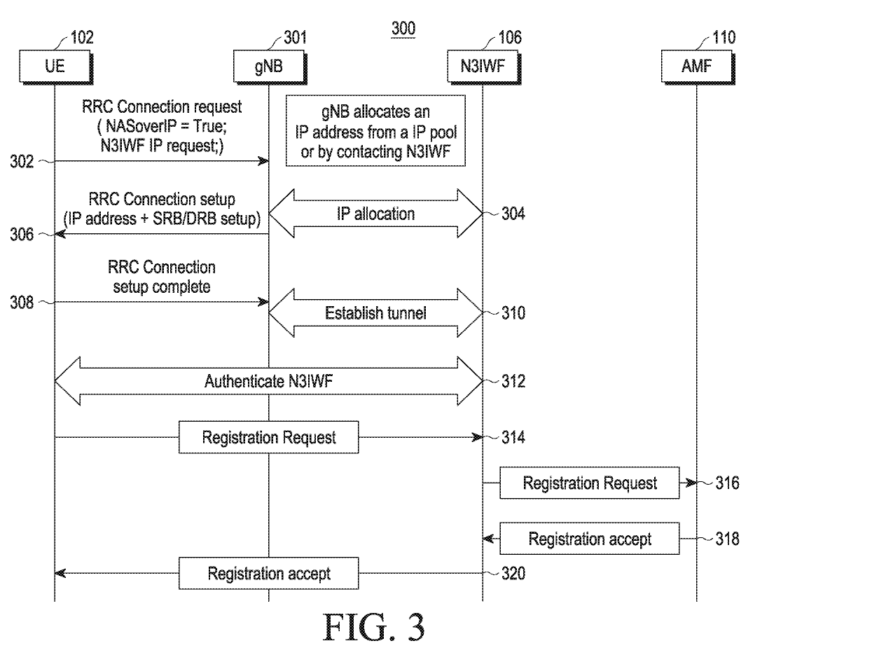

FIG. 3 is a signal flow diagram 300 illustrating example operations for transporting non-access stratum messages over an Internet Protocol connection, according to various example embodiments. As shown, at operation 302, the UE 102 sends an RRC connection request to the gNB 301. The RRC connection request may include an indication that NAS-over-IP is set to true. The RRC connection request may also include a request for an N3IWF IP address.

At operation 304, the gNB 301 assigns the IP address to the UE 102 based on the request. The gNB 301 allocates the IP address from an IP pool maintained by the gNB 301 for the UE 102 during the RRC connection setup procedure. Alternatively, the gNB 301 allocates the IP address by communicating with the interworking function 106 to obtain an IP address for the UE 102.

At operation 306, the gNB 301 sends an RRC connection setup message to the UE 102. The RRC connection setup message may include the allocated IP address. The gNB 301 establishes a signaling radio bearer (SRB) for NAS over IP functionality as part of the initial RRC setup. The gNB 301 may establish a data radio bearer (DRB) for NAS over IP functionality as part of the initial RRC setup. The RRC connection setup operation 306 establishes the radio bearer configuration for transporting IP-encapsulated NAS messages between the UE 102 and the gNB 301.

At operation 308, the UE 102 sends an RRC connection setup complete message to the gNB 301. The RRC connection setup complete confirms that the UE 102 has received the allocated IP address and has configured the radio bearer for NAS over IP communication.

At 310, the gNB 301 establishes a tunnel for communication with the interworking function 106. The tunnel establishment configures the data path for forwarding IP-encapsulated NAS messages from the gNB 301 to the interworking function 106.

At operation 312, the UE 102 establishes an IPsec tunnel with the interworking function 106 for secure NAS over IP communication. The IPsec tunnel provides encryption and authentication for NAS messages transported over the data plane. The UE 102 establishes the IPsec tunnel with the N3IWF or the TNGF for secure NAS over IP communication.

At operation 314, the UE 102 sends a registration request to the interworking function 106. The registration request is encapsulated in the IP packet using the internet-protocol based transport selected from a group including transmission control protocol (TCP), hypertext transfer protocol (HTTP), and quick UDP internet connections (QUIC). The registration request transmission operation 314 corresponds to transmitting IP packets to the network-side interworking network function for delivery to a core-network function mobility management entity, wherein the IP packets correspond to encapsulated one or more NAS messages.

The interworking function 106 performs a registration request forwarding operation 316. At operation 316, the interworking function 106 forwards the registration request to the AMF 110. The interworking function 106 extracts the NAS message from the IP packet and delivers the NAS message to the AMF 110 for processing.

The AMF 110 processes the registration request and sends a registration accept response back to the interworking function 106 at operation 318. For example, at operation 318, the AMF 110 transmits a registration accept message to the interworking function 106. The registration accept message confirms successful registration of the UE 102 with the core network.

At operation 320, the interworking function 106 delivers the registration accept message to the UE 102. The registration accept message may be encapsulated in the IP packet and transmitted to the UE 102 over the established IP connection. The registration accept delivery operation 320 completes the registration procedure over the IP-based data plane.

The UE 102 transmits IP packets to the network-side interworking network function until the IP connection between the UE 102 and the network-side interworking network function is disconnected. The IP address assigned by the gNB 301 is retained by the UE 102 until another IP address is allocated by the RAN node 104. The UE 102 continues to encapsulate NAS messages into IP packets and transmit the IP packets to the interworking function 106 for all subsequent NAS signalling procedures.

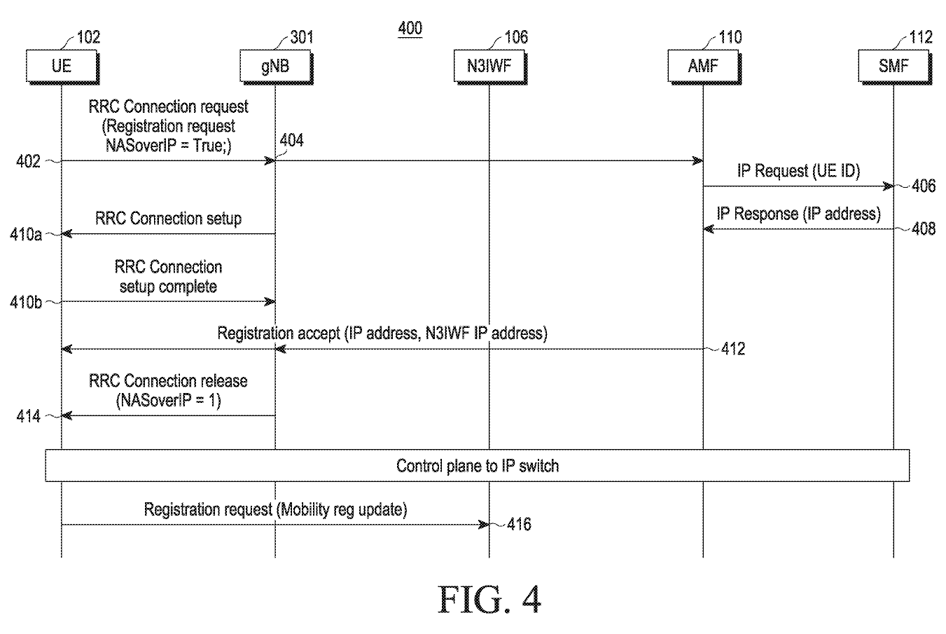

FIG. 4 is a signal flow diagram 400 illustrating example operations for switching from the control plane to IP for non-access stratum message transfer, according to various example embodiments. As shown, at operation 402, the UE 102 sends the RRC connection request to the gNB 301. The RRC connection request may include a registration request with an indication that NASoverIP is set to True.

At operation 404, the gNB 301 transmits the registration request to the AMF 110. Then, at operation 406, the AMF 110 sends a request to the SMF 112, including a UE identifier, to request an IP address for the UE 102. The operation 406 enables the AMF 110 to obtain the IP address allocation for the UE 102 from the SMF 112.

The SMF 112 responds with an IP response operation 408. At operation 408, the SMF 112 provides the requested IP address back to the AMF 110. The IP response operation 408 delivers the IP address that will be assigned to the UE 102 for NAS over IP communication.

Concurrently or subsequently, the gNB 301 performs an RRC connection setup operation 410a. At operation 410a, the gNB 301 sends the RRC connection setup message to the UE 102 to establish the RRC connection. The UE 102 completes this process by sending an RRC connection setup complete message back to the gNB 301 in an RRC connection setup complete operation 410b. The RRC connection setup operation 410aand the RRC connection setup complete operation 410b establish the radio connection between the UE 102 and the gNB 301.

At operation 412, the AMF function 110 sends a registration accept message to the UE 102 via the gNB 301. The registration accept message may include the IP address allocated to the UE 102 and the IP address of the interworking function 106.

The gNB 301 then performs an RRC connection release operation 414. At operation 414, the gNB 301 sends an RRC connection release message to the UE 102. The RRC connection release message may include the indicator NASoverIP set to 1, signaling that subsequent NAS signalling is to be performed over the data plane. The RRC connection release operation 414 triggers a control plane to the IP switch at the UE 102.

The UE 102 initiates a mobility registration request operation 416. At operation 416, the UE 102 sends a mobility registration update through the interworking function 106 to the AMF 110. The mobility registration request operation 416 demonstrates that after the switch, NAS messages are transported over the IP data plane through the interworking function 106 rather than through the traditional control plane path.

The network-side interworking network function is selected from a group including N3IWF, TNGF, UPF enhanced to anchor NAS signalling, and the new network function configured to process NAS messages over IP transport. The interworking function 106 shown in the signaling flow diagram 400 represents any of these network function types configured to receive and process NAS messages transported over the data plane.

The IP address provided in the registration accept message is retained by the UE 102 until another IP address is allocated by the RAN or SMF node. The UE 102 retains the IP address for a configurable amount of time controlled by a timer set by the network. The timer enables the network to manage IP address retention at the UE 102 and allows the UE 102 to switch back to IP-based NAS signalling using the retained IP address if desired.

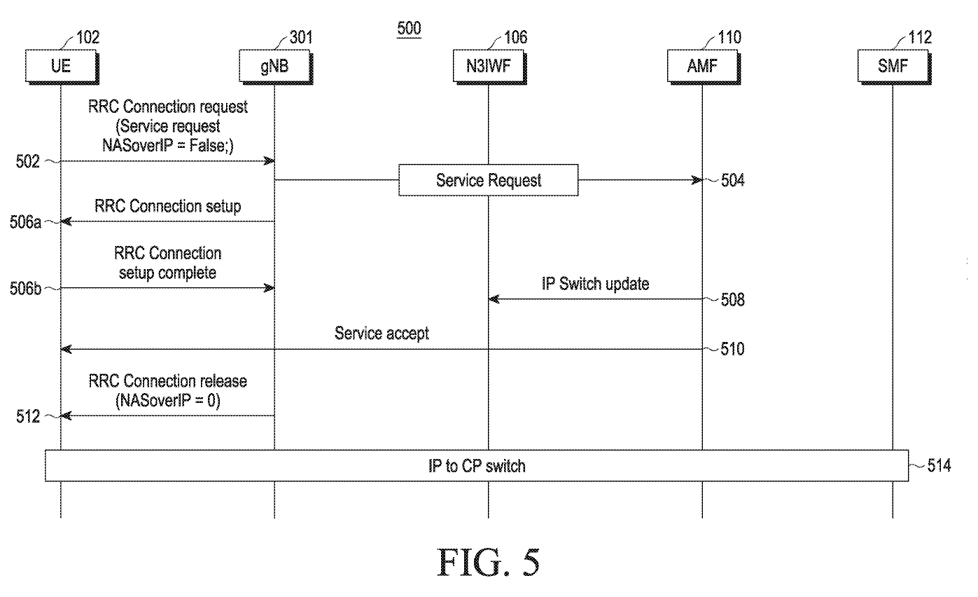

FIG. 5 is a signal flow diagram 500 illustrating example operations for switching non-access stratum message transfer from Internet Protocol to the control plane, according to various example embodiments.

The signaling flow diagram 500 begins with an RRC connection request operation 502, in which the UE 102 transmits the RRC connection request to the gNB 301. The RRC connection request may include a service request with a NASoverIP parameter set to FALSE, indicating that the UE 102 switches NAS signalling from IP back to the control plane.

At operation 502, the gNB 301 performs a service request operation 504, in which the gNB 301 forwards the service request to the AMF 110 via the N3IWF 106. The gNB 301 then transmits an RRC connection setup message to the UE 102 in an RRC connection setup operation 506a. The UE 102 responds with an RRC connection setup complete message to the gNB 301 in an RRC connection setup complete operation 506b, completing the radio connection establishment.

At operation 508, the AMF 110 communicates with the SMF 112 to update the network regarding the change in NAS signalling mode. The AMF 110 updates the interworking function 106 that NAS signalling is currently over the control plane when the UE 102 switches from IP to the control plane.

At operation 510, the AMF 110 transmits a service accept message to the gNB 301. The gNB 301 subsequently releases the RRC connection by transmitting an RRC connection release message to the UE 102 in an RRC connection release operation 512. The RRC connection release message may include a NASoverIP parameter set to 0, confirming that NAS signalling proceeds over the control plane.

The signaling flow diagram 500 concludes with an IP to CP switch operation 514, which represents the transition of NAS message transfer from IP to CP between the UE 102 and the interworking function 106. The UE 102 retains the IP address assigned by the gNB 301 for a configurable amount of time in case the UE 102 wishes to switch back to IP-based NAS signalling.

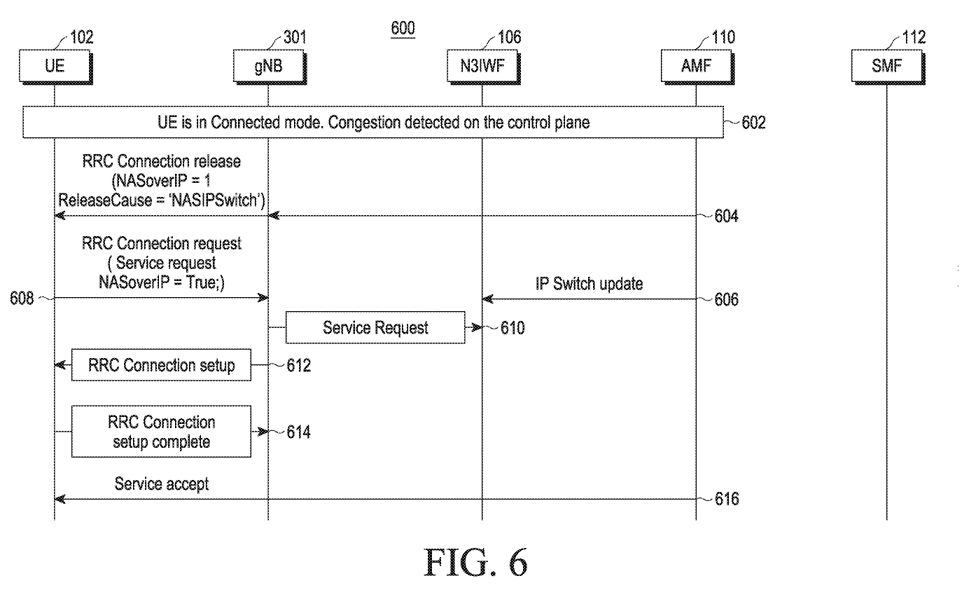

FIG. 6 is a signal flow diagram 600 illustrating example operations for a network-initiated Internet Protocol switch procedure, according to various example embodiments.

As shown, at operation 602, upon detecting congestion or other network conditions warranting a switch to IP-based NAS signalling, the AMF 110 initiates the transition process. The network initiates switching of NAS signalling to IP for load balancing purposes or other operational reasons.

At operation 604, the AMF 110 sends an RRC connection release message through the gNB 301 to the UE 102. The RRC connection release message may include a NASoverIP parameter set to one and a ReleaseCause set to NASIPSwitch, instructing the UE 102 to switch NAS signalling to the IP plane. The network initiates switching of NAS signalling to IP by releasing the existing RRC connection with a release cause NASIPSwitch. The network provides a timer indicating how long NAS signalling is to remain over IP when initiating the switch. This timer allows the network to control the duration of IP-based NAS signalling before the UE 102 reverts to control plane signalling.

Concurrently or subsequently, an IP switch update operation 606 is performed. At operation 606, the AMF 110 communicates with the interworking function 106 to update the IP switch status, preparing the network for receiving NAS messages over the IP plane.

In response to the RRC connection release, the UE102 initiates an RRC connection request operation 608 by sending an RRC connection request to the gNB 301. The RRC connection request may include a service request with the NASoverIP parameter set to TRUE, indicating the UE 102 is prepared to conduct NAS signalling over the IP plane.

A service request operation 610 follows, where the gNB 301 forwards the service request to the interworking function 106 rather than to the AMF 110, reflecting the switch to IP-based NAS transport.

The gNB 301 then performs an RRC connection setup operation 612 by sending an RRC connection setup message to the UE 102, establishing the radio connection with appropriate bearers for IP-based NAS signalling.

The UE 102 completes the connection establishment by sending an RRC connection setup complete message to the gNB 301 in an RRC connection setup complete operation 614.

The network-initiated IP switch procedure 600 concludes with a service accept operation 616. At operation 616, a service accept message is sent from the interworking function 106 to the UE 102, confirming successful completion of the network-initiated switch to NAS over IP signalling. All signalling proceeds over IP until the timer expires, at which point the UE 102 reverts to control plane signalling.

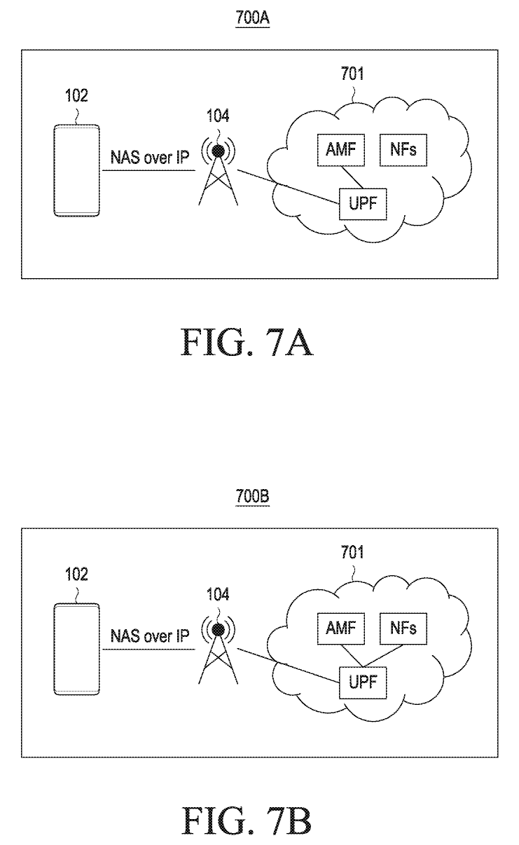

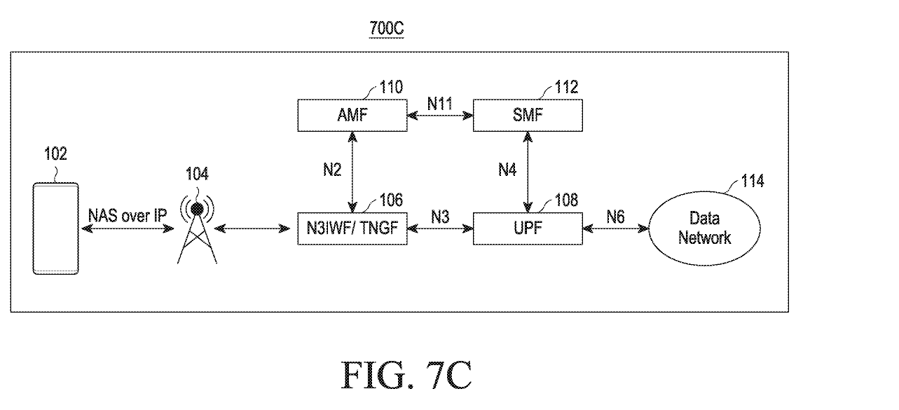

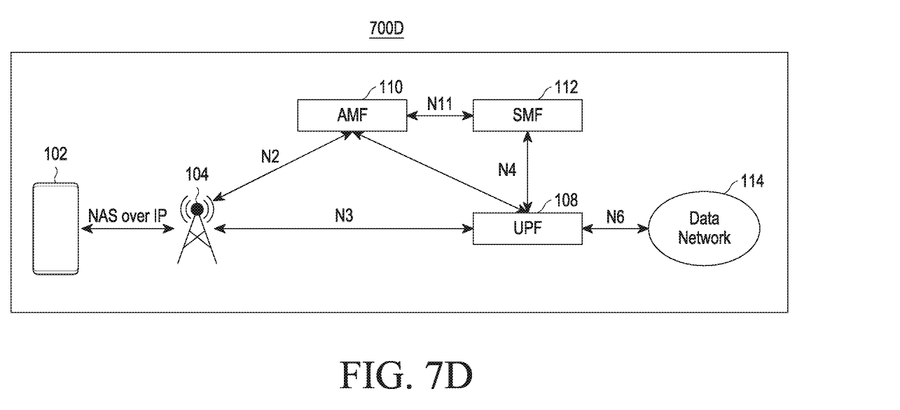

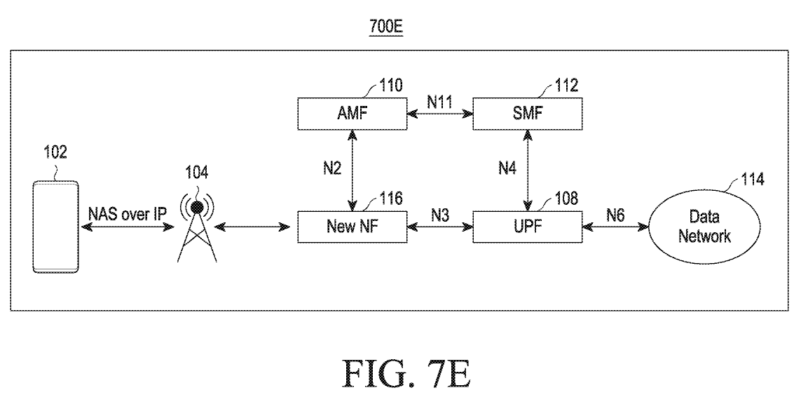

FIGS. 7A and 7B are diagrams illustrating example network architectures for the non-access stratum over Internet Protocol communication, according to various example embodiments. For example, FIG. 7A illustrates a NAS over IP network architecture 700A depicting a configuration for transporting non-access stratum signaling over a data plane in a wireless communication system. FIG. 7B illustrates a NAS over IP network architecture 700B depicting a similar configuration for transporting non-access stratum signaling over a data plane.

In the NAS over IP network architecture 700A, the UE 102 is positioned on the left side and communicates via NAS over IP with the RAN node 104. The RAN node 104 connects to a cloud-based core network 701. The cloud-based core network contains an AMF, network functions (NFs), and a UPF. The AMF and NFs are positioned in an upper portion of the cloud-based core network 701, while the UPF is positioned below the AMF and NFs. This arrangement indicates a separation between control plane functions and user plane functions within the core network.

In the NAS over IP network architecture 700B, the UE 102 communicates via NAS over IP with the RAN node 104. The RAN node 104 connects to the cloud-based core network 701 that contains an AMF, NFs, and the UPF arranged in a manner similar to the NAS over IP network architecture 700A.

Both the NAS over IP network architecture 700A and the NAS over IP network architecture 700B demonstrate the concept of transmitting NAS messages over Internet Protocol rather than through traditional control plane signaling. In traditional wireless communication systems, NAS messages are transmitted over a control plane path to a single common network function, such as the AMF, which then routes the NAS messages to different network functions. In contrast, the NAS over IP network architecture 700A and the NAS over IP network architecture 700B enable the UE 102 to establish an IP connection through the radio access network node to reach the core network functions directly.

The UE 102 in the NAS over IP network architecture 700A and the NAS over IP network architecture 700B encapsulate NAS messages into IP packets and transmit the IP packets over a data plane connection. The presence of the UPF in both the NAS over IP network architecture 700A and the NAS over IP network architecture 700B indicates a role of the UPF in anchoring NAS signaling when transported over the data plane. The AMF and other NFs receive and process the NAS messages that have been encapsulated in IP packets and forwarded through the network infrastructure.

This approach of transmitting NAS messages over IP provides flexibility in network deployment. New services are deployed dynamically without affecting multiple network functions, as NAS messages are routed directly to relevant network functions from an interworking function rather than passing through a single common network function. The NAS over IP network architecture 700A and the NAS over IP network architecture 700B support both 3GPP access and non-3GPP access paths for delivering signaling messages to the core network functions.

FIG. 7C is a diagram illustrating an example network architecture 700C using an interworking function as an anchor point, according to various example embodiments. The network architecture diagram 700C depicts the arrangement and interconnection of network components that enable NAS over IP functionality using the interworking function 106 as an anchor point for NAS signalling transported over the data plane.

As shown, the UE 102 via NAS over IP with the RAN node 104. The RAN node 104 serves as the access point for the UE 102 to connect to the network infrastructure. The UE 102 transmits NAS messages encapsulated in IP packets to the RAN node 104 over a wireless communication channel. The RAN node 104 receives the IP-encapsulated NAS messages and forwards the IP-encapsulated NAS messages to the interworking function 106.

The RAN node 104 connects to the interworking function 106, e.g., N3IWF/TNGF 106. The interworking function 106 serves as the anchor point for NAS signalling transported over the data plane. The connection between the RAN node 104 and the interworking function 106 enables the forwarding of IP-encapsulated NAS messages from the UE 102 to the core network. The interworking function 106 may comprise N3IWF or TNGF. In accordance with the disclosure, the interworking function 106 is made available over 3GPP access to enable NAS signalling over the data plane, allowing the UE 102 to perform NAS procedures over IP rather than through traditional control plane signalling paths.

The interworking function 106 connects to the AMF 110 via an N2 interface N2. The N2 interface N2 enables the interworking function 106 to forward NAS messages to the AMF 110 for processing. The AMF 110 handles mobility management and connection management functions within the core network. When the interworking function 106 receives IP-encapsulated NAS messages from the UE 102 through the RAN node 104, the interworking function 106 extracts the NAS messages from the IP packets and delivers the NAS messages to the AMF 110 via the N2 interface N2.

The AMF 110 is connected to the SMF 112 via an N11 interface N11. The N11 interface N11 carries session management signalling between the AMF 110 and the SMF 112. The SMF 112 manages session establishment, modification, and release for the UE 102. The SMF 112 also handles IP address allocation for the UE 102 in coordination with the AMF 110.

The SMF 112 connects to the UPF 108 via an N4 interface N4. The N4 interface N4 enables the SMF 112 to configure the UPF 108 for packet processing and routing. The SMF 112 uses the N4 interface N4 to establish, modify, and release user plane sessions at the UPF 108.

The interworking function 106 also connects to the UPF 108 via an N3 interface N3. The N3 interface N3 enables user plane data transfer between the interworking function 106 and the UPF 108. The UPF 108 handles user plane packet processing and routing for data traffic from the UE 102.

The UPF 108 connects to the data network 114 via an N6 interface N6. The N6 interface N6 provides connectivity between the UPF 108 and external networks accessible through the wireless communication system 100. The data network 114 represents external networks that the UE 102 accesses through the UPF 108.

The network architecture diagram 700C illustrates a configuration where the interworking function 106, which is used for non-3GPP access in conventional deployments, is made available over 3GPP access to enable NAS signalling over the data plane. This arrangement allows the UE 102 to perform NAS procedures over IP rather than through traditional control plane signalling paths. When the UE 102 indicates a preference for NAS-over-IP, the RAN node 104 allocates an IP address to the UE 102 during radio connection setup and establishes an IP connection over a radio bearer in the data plane for NAS message transport to the interworking function 106.

FIG. 7D is a diagram illustrating an example network architecture 700D using a user plane function as the anchor point, according to various example embodiments. The network architecture diagram 700D depicts a configuration where the user plane function 108 serves as the anchor point for NAS message transfer over the data plane.

The network architecture diagram 700D may include the UE 102, the RAN node 104, the UPF 108, the AMF 110, the SMF 112, and the data network 114. The working and interconnection of these various components have been explained in reference to FIG. 7C. Hence, the same is not repeated here for the sake of brevity of the disclosure.

In the network architecture diagram 700D, the UPF 108 serves as the anchor point for NAS signalling transmitted over the data plane. The UPF 108 operates in one of two modes for handling NAS messages, e.g., a transparent relay mode and an active relay mode.

In the transparent relay mode, the UPF 108 operates as a transparent relay where states are maintained at the AMF 110, and communication happens via the UPF 108. In this mode, the UPF 108 receives IP-encapsulated NAS messages from the UE 102 through the RAN node 104 via the N3 interface N3. The UPF 108 extracts the NAS messages from the IP packets and forwards the NAS messages to the AMF 110. The AMF 110 maintains NAS states and context for the UE 102 and processes the NAS messages. The UPF 108 transfers NAS messages between the UE 102 and the AMF 110 without maintaining NAS state information. In the transparent relay mode, the UPF 108 functions as a conduit for NAS message transfer without performing state processing operations.

In the active relay mode, the UPF 108 operates as an active relay that sends messages directly to the AMF 110, the SMF 112, a short message service function (SMSF), and a location management function (LMF). In this mode, the UPF 108 maintains NAS states and context for the UE 102. The UPF 108 receives IP-encapsulated NAS messages from the UE 102 through the RAN node 104 via the N3 interface N3. The UPF 108 processes the NAS messages and determines the appropriate core network function to receive each NAS message based on the message type and content. The UPF 108 routes NAS messages directly to the relevant core network function, such as the AMF 110 for mobility management messages, the SMF 112 for session management messages, the SMSF for short message service messages, or the LMF for location management messages. The UPF 108 maintains NAS state information and context for the UE 102, enabling optimized message transfer without requiring an additional hop through the AMF 110 for all NAS message types.

The network architecture diagram 700D represents a deployment option where the UPF 108 is enhanced to anchor NAS signalling transmitted over the data plane. This configuration enables the RAN node 104 to allocate an IP address to the UE 102 during radio connection setup and establish an IP connection over a radio bearer in the data plane for NAS message transport to the user plane function 108.

FIG. 7E is a diagram illustrating an example network architecture diagram using a new network function as the anchor point, according to various example embodiments. The network architecture diagram 700E depicts a configuration where the new network function 116 serves as the anchor point for NAS over IP communication.

The network architecture diagram 700E may include the UE 102, the RAN node 104, the UPF 108, the AMF 110, the SMF 112, the data network 114, and the new network function 116. The UE 102 communicates with the RAN node 104 using NAS over IP signalling. The UE 102 transmits NAS messages encapsulated in IP packets to the RAN node 104 over a wireless communication channel.

The RAN node 104 connects to the new network function 116 via the N2 interface N2. The N2 interface N2 enables the RAN node 104 to forward IP-encapsulated NAS messages from the UE 102 to the new network function 116. The new network function 116 is positioned to receive NAS messages encapsulated in IP packets from the UE 102 through the RAN node 104. The new network function 116 is configured to process NAS messages transported over IP and forward the NAS messages to the AMF 110 for mobility management operations.

The new network function 116 connects to the UPF 108 via the N3 interface N3. The N3 interface N3 enables user plane data transfer between the new network function 116 and the UPF 108. The UPF 108 provides connectivity to the data network 114 through the N6 interface N6.

The AMF 110 communicates with the SMF 112 via the N11 interface N11. The N11 interface N11 carries session management signalling between the AMF 110 and the SMF 112. The SMF 112 connects to the UPF 108 through the N4 interface N4. The N4 interface N4 enables the SMF 112 to configure the UPF 108 for packet processing and routing.

The new network function 116 receives IP-encapsulated NAS messages from the UE 102 through the RAN node 104. The new network function 116 extracts the NAS messages from the IP packets and processes the NAS messages. The new network function 116 forwards mobility management-related NAS messages to the AMF 110 for processing. The new network function 116 routes NAS messages to the appropriate core network function based on the message type and content.

In the network architecture diagram 700E, the network provisions the UE 102 with IP addresses of other network functions. The network provides the UE 102 with IP addresses of a policy control function (PCF), the SMF 112, and a unified data management (UDM) function. The provisioning of IP addresses of other network functions enables the UE 102 to communicate directly with the PCF, the SMF 112, and the UDM function. This direct communication enables a distributed NAS architecture where the UE 102 reaches corresponding network functions on the network with IP, without routing all NAS messages through a single common network function. The UE 102 uses the provisioned IP addresses to establish IP connections with the PCF for policy-related NAS procedures, with the SMF 112 for session management NAS procedures, and with the UDM function for subscriber data-related NAS procedures.

The network architecture diagram 700E represents an example deployment option where a dedicated network function handles NAS over IP signalling rather than utilizing existing interworking functions or user plane functions. This arrangement allows the RAN node 104 to allocate an IP address to the UE 102 during radio connection setup and establish an IP connection over a radio bearer in the data plane for NAS message transport to the new network function 116. The new network function 116 is configured to process NAS messages over IP transport and coordinate with other core network functions to provide mobility management, session management, and other NAS services to the UE 102.

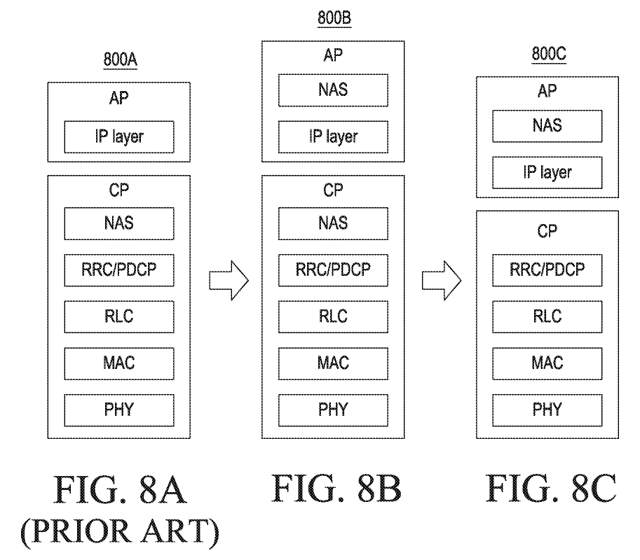

FIG. 8A is a diagram illustrating an example protocol stack architecture 800A depicting configurations for non-access stratum layer placement, according to the prior art. The protocol stack architecture diagram 800A shows the protocol stack arrangements at the UE 102.

As shown, the traditional protocol stack may include, from top to bottom, an application processor (AP) layer, an internet protocol (IP) layer, a NAS layer, a radio resource control/packet data convergence protocol (RRC/PDCP) layer, a radio link control (RLC) layer, a medium access control (MAC) layer, and a physical (PHY) layer. A communications processor (CP) encompasses the layers from the NAS layer through the PHY layer. In the traditional protocol stack, the NAS layer resides within the communications processor and operates below the IP layer. The NAS layer handles mobility management, session management, and other control plane functions by exchanging NAS messages with the AMF 110 through the RRC/PDCP layer.

FIG. 8B is a diagram illustrating an example protocol stack architecture 800B depicting configurations for non-access stratum layer placement, according to various example embodiments. As shown, the AP layer contains a NAS component and an IP layer. The CP layer contains a separate NAS component, an RRC/PDCP layer, an RLC layer, a MAC layer, and a PHY layer. In this partial NAS configuration, an NAS client is placed at the AP layer while remaining NAS functions stay at the CP layer. The NAS client at the AP layer handles application-aware NAS operations and communicates with the NAS component at the CP layer for radio-related NAS procedures. This configuration enables the UE 102 to perform certain NAS operations at the AP layer while maintaining compatibility with traditional control plane signalling through the CP layer.

FIG. 8C is a diagram illustrating an example protocol stack architecture 800C depicting configurations for non-access stratum layer placement, according to various example embodiments. As shown, the complete NAS layer resides at the AP layer. In this arrangement, the AP layer contains the NAS layer and the IP layer positioned above the RRC/PDCP layer. The CP layer contains the RRC/PDCP layer, the RLC layer, the MAC layer, and the PHY layer. In this complete NAS at AP configuration, the NAS protocol layer is moved above the IP layer in the protocol stack of the UE 102 when operating in NAS over IP mode. The complete NAS protocol is moved to the AP layer of the UE 102 for NAS over IP operation. The NAS layer at the AP layer encapsulates NAS messages into IP packets using a transport protocol selected from transmission control protocol (TCP), hypertext transfer protocol (HTTP), or quick UDP internet connections (QUIC). The IP-encapsulated NAS messages are passed to the RRC/PDCP layer at the CP layer for transmission over the radio interface.

The protocol stack architecture diagrams 800A-800C demonstrate how the NAS layer is repositioned from the CP layer to the AP layer, enabling NAS messages to be transported over the IP layer rather than the control plane. This architectural flexibility allows for different deployment options depending on network requirements and service configurations. When the NAS layer operates at the AP layer, the NAS layer has access to application-level information and processing capabilities of the AP layer. The AP layer provides computational resources for complex operations, including artificial intelligence and machine learning use cases that involve models requiring the computational power of the AP layer.

When NAS messages are transmitted over a data radio bearer, the NAS messages are encapsulated in PDCP packets. The NAS layer at the AP layer generates an NAS message and encapsulates the NAS message into an IP packet. The IP packet containing the NAS message is passed to the RRC/PDCP layer at the CP layer. The RRC/PDCP layer encapsulates the IP packet into a PDCP packet for transmission over the data radio bearer. The PDCP packet containing the IP-encapsulated NAS message is processed by the RLC layer, the MAC layer, and the PHY layer for transmission over the wireless communication channel to the RAN node 104. The RAN node 104 receives the PDCP packet, extracts the IP packet, and forwards the IP packet to the interworking function 106, the user plane function 108, or the new network function 116, depending on the network architecture configuration.

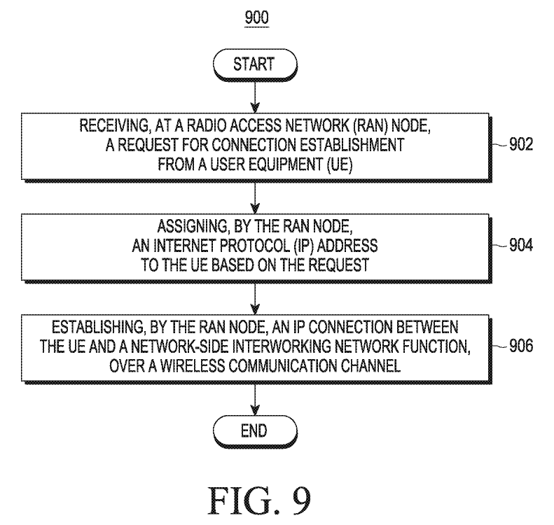

FIG. 9 is a flowchart illustrating an example method 900 for establishing NAS signalling in the wireless communication system, according to various example embodiments. At operation 902, the method 900 may include receiving the request for connection establishment from the UE 102. The request may comprise the indication for using NAS-over-Internet Protocol. The request corresponds to an RRC connection request message transmitted by the UE 102 to the RAN node 104. The indication for using NAS-over-IP is included in the RRC connection request message as a flag or parameter that signals the preference of the UE 102 for IP-based NAS transport. The RAN node 104 processes the request and determines that the UE 102 prefers NAS signalling over the data plane based on the indication.

At operation 904, the method 900 may include assigning the IP address to the UE 102 based on the request. The RAN node 104 allocates the IP address from an IP pool maintained by the RAN node 104. Alternatively, the RAN node 104 obtains the IP address by communicating with the interworking function 106 or another network function. The IP address assigned by the RAN node 104 is retained by the UE 102 until another IP address is allocated by the RAN node 104. The RAN node 104 may include the assigned IP address in an RRC connection setup message transmitted to the UE 102.

At operation 906, the method 900 may include establishing the IP connection between the UE 102 and the network-side interworking network function over a wireless communication channel. The RAN node 104 configures a data radio bearer or a signaling radio bearer for transporting IP-encapsulated NAS messages between the UE 102 and the RAN node 104. The RAN node 104 establishes a tunnel or data path to the network-side interworking network function for forwarding IP packets containing NAS messages from the UE 102.

The network-side interworking network function is selected from a group including N3IWF, TNGF, UPF enhanced to anchor NAS signalling, and a new network function configured to process NAS messages over IP transport. The RAN node 104 selects the network-side interworking network function based on network configuration and the indication received from the UE 102.

At operation 906, the method 900 may include establishing the IP connection between the UE 102 and the network-side interworking network function, over the wireless communication channel. The IP packets correspond to encapsulated one or more NAS messages using an internet-protocol based transport selected from a group including TCP, HTTP, and QUIC. The UE 102 encapsulates NAS messages into IP packets and transmits the IP packets to the RAN node 104 over the established radio bearer. The RAN node 104 forwards the IP packets to the network-side interworking network function, which extracts the NAS messages and delivers the NAS messages to the AMF 110.

The RAN node 104 transmits the IP packets to the network-side interworking network function until the IP connection between the UE 102 and the network-side interworking network function is disconnected. The IP connection remains active for the duration of the NAS signalling session, enabling continuous transport of NAS messages over the data plane.

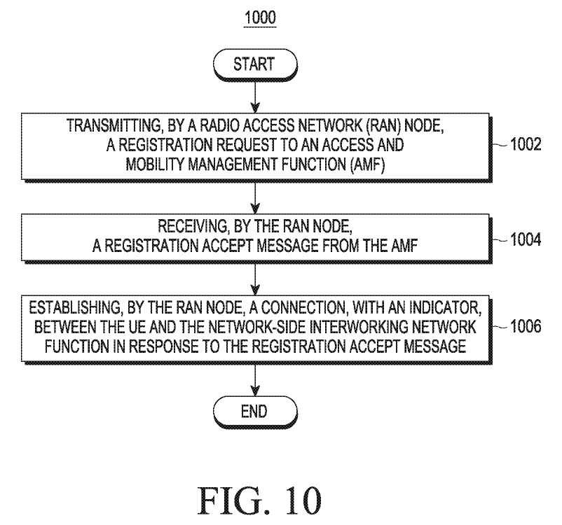

FIG. 10 is a flowchart illustrating an example method of switching NAS signalling from a control plane to a data plane in the wireless communication system, according to various example embodiments.

As shown, at operation 1002, the method 1000 may include transmitting the registration request to the AMF 110. The registration request corresponds to the RRC connection request received from the UE 102. The RRC connection request may include a registration request with an indication that NASoverIP is set to True. The RAN node 104 extracts the registration request from the RRC connection request and forwards the registration request to the AMF 110 via the N2 interface N2. The operation 1002 initiates the registration procedure through the control plane path while preparing for subsequent transition to the data plane.

At operation 1004, the method 1000 may include receiving the Registration Accept message from the AMF 110. The registration accept message may comprise the IP address for the UE 102 and the IP address of the network-side interworking network function. The AMF 110 coordinates with the SMF 112 to obtain the IP address for the UE 102 before transmitting the registration accept message. The registration accept message may include the IP address allocated to the UE 102 for NAS over IP communication and the IP address of the interworking function 106 or another network-side interworking network function to which the UE 102 will connect for data plane NAS signalling. The RAN node 104 stores the IP addresses received in the registration accept message for use in establishing the data plane connection.

At operation 1006, the method 1000 may include establishing, in response to the Registration Accept message, the connection with the indicator between the UE 102 and the network-side interworking network function. The indicator may be NASoverIP, indicating that subsequent NAS signalling is to be performed over the data plane. The RAN node 104 transmits the RRC connection release message to the UE 102 with the NASoverIP indicator set to 1, signaling that subsequent NAS signalling is to be performed over the data plane through the network-side interworking network function. The RRC connection release message triggers the UE 102 to switch from control plane NAS signalling to data plane NAS signalling. Following the RRC connection release, the UE 102 establishes a new RRC connection and uses the IP address provided in the Registration Accept message to communicate NAS messages over the data plane to the network-side interworking network function.

The network-side interworking network function is selected from a group including N3IWF, TNGF, UPF enhanced to anchor NAS signalling, and the new network function configured to process NAS messages over IP transport. The RAN node 104 directs the UE 102 to the appropriate network-side interworking network function based on the IP address provided in the Registration Accept message from the AMF 110.

The IP address provided in the registration accept message is retained by the UE 102 until another IP address is allocated by the RAN node 104. The UE 102 uses the retained IP address for all subsequent NAS signalling over the data plane. The UE 102 retains the IP address for a configurable duration controlled by a timer set by the network, enabling the UE 102 to switch back to IP-based NAS signalling using the retained IP address if the UE 102 transitions to control plane signalling and subsequently returns to data plane signalling.

While the above-discussed operations in FIGS. 9 and 10 are illustrated and described in a particular sequence; the operations may occur in variations to the sequence in accordance with various embodiments. A detailed description related to the various operations of FIGS. 9 and 10 is already covered in the description related to FIGS. 1-8C and may not be repeated here for the sake of brevity.

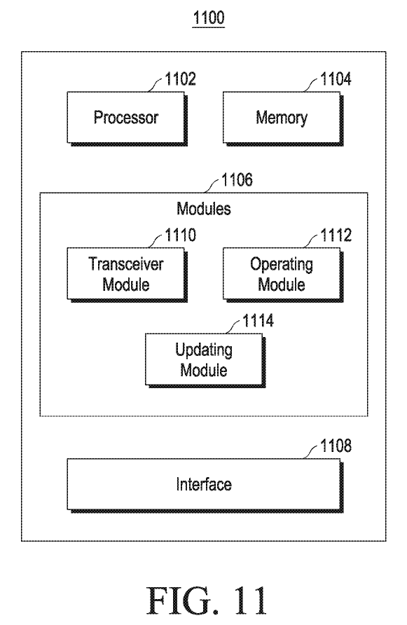

FIG. 11 is a block diagram illustrating an example configuration of an apparatus 1100 for establishing NAS message signalling in the wireless communication system 100 using the UE 102, according to various example embodiments.

In an embodiment, the apparatus 1100 may correspond to the UE 102. It should be noted that FIGS. 1 and 11 have been explained in conjunction with each other for the sake of brevity of the disclosure.

The apparatus 1100 may include one or more processors (e.g., including processing circuitry) 1102 (hereinafter referred to as the processor 1102), memory 1104, one or more modules (e.g., including various circuitry and/or executable program instructions)_1106, and a communication interface (e.g., including communication circuitry) 1108. The one or more processors 1102 may be operatively coupled to the memory 1104, the modules 1106, and the communication interface 1108.

In an embodiment, the processor 1102 may include at least one data processor for executing processes in a virtual storage area network. The processor 1102 may include specialized processing units such as integrated system (bus) controllers, memory management control units, floating point units, graphics processing units, digital signal processing units, etc. In an embodiment, the processor 1102 may include a CPU, a GPU, or both. The processor 1102 may be one or more general processors, DSPs, application-specific integrated circuits, FPGAs, servers, networks, digital circuits, analog circuits, combinations thereof, or other now known or later developed devices for analyzing and processing data. The processor 1102 may execute a software program, such as code generated manually (e.g., programmed), to perform the desired operation. The processor 1102 may implement various techniques, such as, but not limited to, image processing, data extraction, artificial intelligence (AI), machine learning (ML), deep learning (DL), and so forth, to achieve the desired objective. Thus, the processor 1102 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited /disclosed functions, e.g., in a distributed manner. At least one processor may execute program instructions to achieve or perform various functions.

In an embodiment, the processor 1102 may be configured to perform the functions of the apparatus 1100/the UE 102.

The processor 1102 may be disposed in communication with one or more I/O devices, such as the RAN node 104, via the communication interface 1108. The interface 1108 may employ communication CDMA, HSPA+, GSM, LTE, 5G, 6G, WiMax, or the like, etc.

In an embodiment, the processor 1102 may be disposed in communication with a communication network via a network interface. In an embodiment, the network interface may be the communication interface 1108. The network interface may connect to the communication network to enable connection of the apparatus 1100 with the outside environment and/or device/system. The network interface may employ connection protocols, including, without limitation, direct connect, ethernet (e.g., twisted pair 10/100/1000 Base T), TCP/IP, token ring, IEEE 802.11/b/g/n/x, etc. The communication network may include, without limitation, a direct interconnection, LAN, WAN, wireless network (e.g., using WAP), the Internet, etc. Using the network interface and the communication network, the apparatus 1100 may communicate with other devices. The network interface may employ connection protocols including, but not limited to, direct connect, ethernet (e.g., twisted pair 10/100/1000 Base T), TCP/IP, token ring, IEEE 802.11/b/g/n/x, etc.

The memory 1104 may be communicatively coupled to the processor 1102. The memory 1104 may be configured to store data and instructions executable by the processor 1102. In an embodiment, the memory 1104 may communicate via a bus within the apparatus 1100. The memory 1104 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 1104 may include a cache or random-access memory for the processor 1102. In alternative examples, the memory 1104 is separate from the processor 1102, such as a cache memory of a processor, the system memory, or other memory. The memory 1104 may be an external storage device or database for storing data. The memory 1104 may be operable to store instructions executable by the processor 1102. The functions, acts, or tasks illustrated in the figures or described may be performed by the programmed processor 1102 for executing the instructions stored in the memory 1104. The functions, acts, or tasks are independent of the particular type of instruction set, storage media, processor, or processing strategy, and may be performed by software, hardware, integrated circuits, firmware, micro-code, and the like, operating alone or in combination. Likewise, processing strategies may include multiprocessing, multitasking, parallel processing, and the like. The memory 1104 may further include a database to store the data. Further, the memory 1104 may include an operating system for performing one or more tasks of the apparatus 1100, as performed by a generic operating system in the communications domain.

For the sake of brevity, the architecture and standard operations of the processor 1102 and the memory 1104 are not discussed in detail. In an embodiment, the memory 1104 may be configured to store the information as required by the processor 1102 to perform the techniques described herein.

The modules 1106, amongst other things, include routines, programs, objects, components, data structures, etc., which perform particular tasks or implement data types. The modules 1106 may also be implemented as signal processor(s), state machine(s), logic circuitries, and/or any other device or component that manipulates signals based on operational instructions. The modules 1106 may be configured to one or more operations of the apparatus 1100 and/or the processor 1102.

The modules 1106 can be implemented in hardware, instructions executed by a processing unit, or by a combination thereof. The processing unit can comprise a computer, the processor 1102, a state machine, a logic array, or any other suitable devices capable of processing instructions. The processing unit can be a general-purpose processor that executes instructions to cause the general-purpose processor to perform the required tasks, or the processing unit can be dedicated to performing the required functions. In an embodiment of the disclosure, the modules 1106 may be machine-readable instructions (software) that, when executed by a processor/processing unit, perform any of the described functionalities. Furthermore, the data serves, amongst other things, as a repository for storing data processed, received, and generated by one or more of the modules. The modules 1106 may include a transceiver module 1110, an operating module 1112, and an updating module 1114.

In an embodiment, the transceiver module 1110 is configured to receive configuration information based on NAS signalling. In an embodiment, the transceiver module 1110 may receive the configuration information from the RAN node 104. In an embodiment, the transceiver module 1110 may receive the configuration information via the communication interface 1108.

In an embodiment, the RAN node 104 conveys the configuration information to the UE 102 via NAS signalling. For example, the AMF 110 transmits NAS messages to the UE 102 that indicate which services and procedures are to be moved to IP and which services and procedures remain with the control plane. Alternatively, the RAN node 104 conveys the configuration information to the UE 102 via policy. The RAN node 104 provisions the UE 102 with policy information that specifies the service path assignments for different NAS services and procedures. For example, consider a connected vehicle that requires mobility management services for safety-critical operations and infotainment services for passenger experience. The RAN node 104 may configure the UE 102 so that mobility management services remain on the control plane for reliability, while infotainment services are routed through the IP path for better bandwidth utilization.

The RAN node 104 may also advertise or broadcast service path information via system information block (SIB) broadcast. The RAN node 104 transmits SIB messages that contain information indicating which NAS services are accessible via the control plane, which NAS services are accessible via the IP path, which NAS services are accessible only on the IP path, and which NAS services are accessible via both paths. The UE 102 receives the SIB broadcast and configures the NAS layer based on the received service path information.

The configuration information is indicative of a set of NAS services carried over a CP path and a set of NAS services carried over an IP path. The operating module 1112 maintains both control plane and IP paths in an active state for the UE 102. For example, a UE 102, such as a connected vehicle, receives configuration information indicating that safety-critical mobility management services use the control plane path while infotainment-related NAS services use the IP path. The transceiver module 1110 stores this configuration in the memory 1104.

The operating module 1112 coordinates with the communication interface 1108 to operate over the CP path and IP path based on the configuration information. The CP path and IP path are maintained in an active state by the RAN node 104 for operation. The operating module 1112 directs NAS messages for services assigned to the control plane path through a SRB via the communication interface 1108. The operating module 1112 directs NAS messages for services assigned to the IP path through a DRB via the communication interface 1108. The communication interface 1108 transmits NAS messages over the appropriate path based on the service assignments stored in the memory 1104. For instance, when the connected vehicle uses mobility management services, the operating module routes these messages through the CP path using a SRB, while infotainment-related NAS services are directed through the IP path using the DRB. This dual-path approach allows the disclosed network to transmit messages over the correct path based on service assignments stored in memory, ensuring optimal performance.

The UE 102 indicates a NASOverCPIP preference in an RRC connection request to operate with both the control plane path and the IP path simultaneously. When the UE 102 sends the RRC connection request to the gNB 301 with the NASOverCPIP indication, the gNB 301 establishes both an SRB and a DRB for NAS signalling. The gNB 301 interacts with the interworking function 106 and allocates an IP address for the UE 102. The gNB 301 forwards signalling on the SRB to the AMF 110 and forwards signalling on the DRB to the interworking function 106 when operating in NAS over CP+IP mode.

Legacy NAS services continue to operate over the control plane while new services operate over the IP domain simultaneously. The UE 102 performs registration procedures and mobility management procedures via the SRB through the control plane path to the AMF 120. The UE 102 obtains services from network functions deployed for new services via the DRB through the IP path to the interworking function 106. This configuration enables the UE 102 to maintain legacy connections over the control plane while using a distributed NAS architecture for services with different network functions over the IP path.

The updating module 1114 is configured to update the configuration information dynamically based on at least one of UE capability, network policy, and service requirements. For example, consider a connected vehicle traveling through a congested urban area. In such a scenario, the network policy may decide to offload certain non-critical NAS services, like infotainment or diagnostics, from the control plane to the IP path. This reduces the signaling load on the control plane, ensuring that essential services like mobility management and safety-critical functions remain unaffected. The updating module 1114 automatically adjusts the routing of NAS messages to reflect this change without requiring manual intervention.

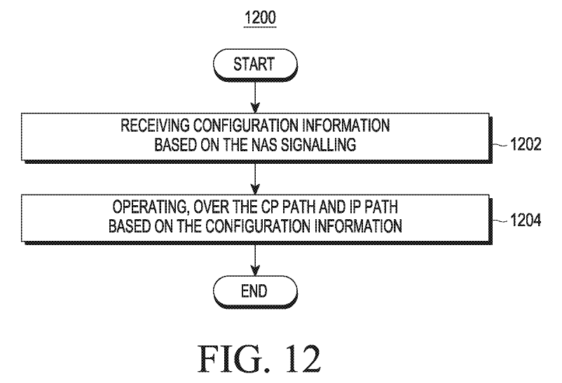

FIG. 12 is a flowchart illustrating an example method 1200 for establishing NAS signalling in the wireless communication system 100 using the UE 102, according to various example embodiments.

At operation 1202, the method 1200 may include receiving configuration information based on NAS signalling. The configuration information is indicative of a set of NAS services carried over a CP path and a set of NAS services carried over an IP path. The configuration information specifies which services and procedures are to be performed over the control plane path and which services and procedures are to be performed over the IP path.

At operation 1204, the method 1200 may include operating over the CP path and IP path based on the configuration information. The CP path and IP path are maintained in the active state by the RAN node 104 for operation. The UE 102 sends NAS messages for services assigned to the control plane path through a SRB and sends NAS messages for services assigned to the IP path through a DRB.

The method 1200 may include updating the configuration information dynamically based on at least one of UE capability, network policy, and service requirements. When the capabilities of the UE 102 change, the UE 102 updates the configuration information to reflect the changed capabilities. When the network policy changes, the network transmits updated configuration information to the UE 102 via NAS signalling or policy provisioning, and the UE 102 updates the service path assignments accordingly. When service requirements change, the UE 102 adjusts the configuration information to route NAS messages for specific services over the appropriate path based on the updated service requirements.

While the above-discussed operations in FIG. 12 are illustrated and described in a particular sequence; the operations may occur in variations to the sequence in accordance with various embodiments. A detailed description related to the various operations of FIG. 12 is already covered in the description related to FIGS. 1 and 11, and may not be repeated here for the sake of brevity.

Accordingly, the disclosure provides various advantages, as discussed in the disclosure.

The operation of the UE 102 using NAS over IP introduces distinct state management characteristics for mobility management that differ from traditional control plane operation. In conventional NAS operation over the control plane, the UE 102 transitions between a 5GMM-IDLE state and a 5GMM-CONNECTED state based on the status of the access stratum connection. When the access stratum connection is released in traditional operation, the UE 102 enters the 5GMM-IDLE state and considers the N1 NAS signalling connection released. This traditional approach requires the UE 102 to perform state transitions and service request procedures to re-establish connectivity when NAS signalling is needed.

When the UE 102 uses NAS over IP in accordance with the disclosure, the UE 102 remains in a connected state corresponding to EMM-CONNECTED or 5GMM-CONNECTED as long as a data bearer for NAS signalling remains established between the UE 102 and the network. The RAN node 104 establishes this data bearer as part of RRC procedures when the UE 102 indicates a preference for NAS-over-IP during connection establishment. The connected state is maintained for the duration that the data bearer remains active, thereby providing continuous connectivity for NAS signalling over the data plane without requiring repeated state transitions.

The state management behavior when the UE 102 operates using NAS over IP follows specific transition rules. When the UE 102 is using NAS over IP and is in a 5GMM-IDLE state and receives an indication from RRC that a connection has been established between the UE 102 and the network, the UE 102 considers the N1 NAS signalling connection established and enters the 5GMM-CONNECTED state. Conversely, upon indication from lower layers that the access stratum connection has been released, the UE 102 enters the 5GMM-IDLE state and considers the N1 NAS signalling connection released. This state management approach maintains compatibility with existing mobility management frameworks while enabling the benefits of IP-based NAS transport.

An advantage of NAS over IP is the elimination of the NAS service request procedure. In traditional control plane operation, when the UE 102 is in an idle state and needs to send uplink data or NAS signalling, the UE 102 performs a service request procedure to transition to a connected state and establish the signalling connection. This service request procedure introduces latency and signalling overhead each time the UE 102 needs to communicate with the network after being idle. When using NAS over IP in accordance with the disclosure, always-on connectivity is ensured by the IP connection established between the UE 102 and the network-side interworking network function, such as the interworking function 106. The IP connection provides a persistent data path for NAS message transport, thereby eliminating the need for the UE 102 to perform service request procedures to establish connectivity for NAS signalling. The UE 102 transmits NAS messages over the established IP connection without first performing a service request procedure to transition from an idle state to a connected state, resulting in reduced signalling latency and improved responsiveness.

The NAS over IP architecture of the disclosure provides several operational characteristics that benefit network deployment and operation. The processing load at the radio access network is reduced because the RAN node 104 forwards IP packets containing NAS messages to the network-side interworking network function without performing header inspection and NAS message processing. The RAN node 104 handles NAS messages as IP traffic on the data plane rather than processing NAS protocol data units on the control plane. This reduction in processing requirements at the RAN node 104 enables more efficient utilization of access network resources and supports higher capacity deployments.

The NAS over IP approach of the disclosure enables a distributed approach to NAS signalling that addresses limitations of centralized architectures. In traditional architectures, a single common network function, such as the AMF 110, handles all NAS signalling and routes messages to different network functions. This centralized approach creates complexity at the AMF 110 and requires modifications to multiple network nodes when new services are introduced. With NAS over IP, the UE 102 reaches corresponding network functions on the network with IP, allowing NAS messages to be routed directly to relevant network functions without passing through a single centralized node. This distributed approach reduces the complexity at individual network nodes by distributing NAS message handling across multiple network functions, enabling more flexible and scalable network deployments.

The NAS over IP architecture minimizes and/or reduces NAS states and procedures compared to traditional control plane operation. The elimination of the service request procedure reduces the number of NAS procedures performed by the UE 102, simplifying the protocol stack implementation and reducing signalling overhead. The UE 102 no longer transitions between idle and connected states for NAS signalling purposes when the IP connection remains established, thereby reducing state management complexity at both the UE 102 and the network. This simplification of state management enables more efficient operation and reduces the potential for state synchronization issues between the UE 102 and network functions.

Processing speeds for NAS signalling are improved when using NAS over IP in accordance with the disclosure. The RAN node 104 forwards IP-encapsulated NAS messages without performing control plane processing operations, thereby reducing latency in the access network. The distributed NAS approach enables the UE 102 to communicate directly with relevant network functions, reducing round-trip time delays in accessing particular network functions compared to routing all NAS messages through a single centralized network function. These latency improvements are particularly beneficial for time-sensitive applications and services that require rapid NAS signalling exchanges. For example, in an artificial intelligence and machine learning use case, the UE 102 may need to rapidly exchange NAS messages with network functions to support model updates, inference requests, or coordination with edge computing resources. The NAS over IP architecture enables the UE 102 to leverage the computational capabilities of the Application Processor for complex AI/ML operations while maintaining low-latency NAS signalling through the IP-based data plane. The UE 102 can perform AI/ML inference operations that require coordination with network-side AI/ML functions, with NAS messages transported efficiently over the IP connection to support real-time or near-real-time AI/ML applications. This use case demonstrates how the NAS over IP architecture supports emerging applications that require both computational capability at the UE 102 and efficient network signalling.

The systems and methods described herein may be implemented in any form of computing or electronic device. The term "computer," as used herein, encompasses any device with processing capabilities sufficient to execute instructions. This includes, but is not limited to, personal computers, servers, mobile devices, personal digital assistants, and similar devices.

Such devices may include one or more processors, such as microprocessors, controllers, or other suitable types of processors, capable of executing instructions to control the device's operation. For example, in some implementations using a system-on-a-chip architecture, the processors may include fixed-function blocks (hardware accelerators) that perform parts of the method in hardware rather than software or firmware. Platform software, such as an operating system or similar, may be installed to support the execution of application software.

The described functionality may be implemented in hardware, software, or any combination thereof. When implemented in software, the instructions or code can be stored on or transmitted via a computer-readable medium. Such media include computer-readable storage media, which may be volatile or non-volatile, removable or non-removable, and implemented using any technology for storing information such as program code, data structures, or other data. Examples include, but are not limited to, ROM, EEPROM, RAM, magnetic or optical storage, flash memory, or any other storage medium accessible by a computer. Communication media that facilitate the transfer of software, such as via coaxial cables, fiber optics, DSL, or wireless signals, may also be considered part of computer-readable media.

Alternatively, or in addition, some or all of the described functionality may be implemented using hardware logic components. Examples include, but are not limited to, application-specific integrated circuits, system-on-a-chip systems, field-programmable gate arrays, application-specific standard products, and complex programmable logic devices. In some cases, software instructions may also be implemented in dedicated circuits, such as programmable logic arrays or digital signal processors.

The computing device may operate as a standalone system or as part of a distributed system, where tasks are performed collectively by multiple devices connected via a network. Such devices may communicate over a network connection to perform the described functionality. For instance, software may be stored on a remote computer and accessed by a local device, which may download and execute portions of the software as needed. Similarly, some instructions may be processed locally, while others may execute on remote systems or networks. In some cases, the computing device may be remote and accessible via a communication interface. Storage of program instructions may also be distributed across a network or stored in a combination of local and remote locations. For example, software may reside on a remote computer and be accessed by a local terminal, or the system may execute some software locally while other components operate on remote servers.

Features of any of the examples or embodiments outlined above may be combined to create additional examples or embodiments without losing the intended effect. It should be understood that the description of an embodiment or example provided above is by way of example only, and various modifications could be made by one skilled in the art. Furthermore, one skilled in the art will recognise that numerous further modifications and combinations of various aspects are possible. Accordingly, the described aspects are intended to encompass all such alterations, modifications, and variations that fall within the scope of the appended claims.

What is claimed is:

1. A method for establishing non-access stratum (NAS) signalling in a wireless communication system, the method comprising:
receiving, by a radio access network (RAN) node, a request for connection establishment from a user equipment (UE), wherein the request comprises an indication for using NAS-over-internet protocol (IP);
assigning, by the RAN node, an IP address to the UE based on the request; and
establishing, by the RAN node, an IP connection between the UE and a network-side interworking network function, over a wireless communication channel.

2. The method as claimed in claim 1, comprising:
transmitting IP packets to the network-side interworking network function for delivery to a core-network function mobility management entity,
wherein the IP packets correspond to encapsulated one or more NAS messages using an internet-protocol based transport selected from a group including: transmission control protocol (TCP), hypertext transfer protocol (HTTP), and quick UDP internet connections (QUIC).

3. The method as claimed in claim 2, comprising:
transmitting the IP packets to the network-side interworking function until the IP connection between the UE and the network-side interworking network function is disconnected.

4. The method as claimed in claim 1, wherein the network-side interworking network function is selected from a group including: a non-third generation partnership project (3GPP) interworking function (N3IWF), a trusted non-3GPP gateway function (TNGF), a user plane function (UPF) enhanced to anchor NAS signalling, and a new network function configured to process NAS messages over IP transport.

5. The method as claimed in claim 1, wherein the IP address is retained by the UE until another IP address is allocated by the RAN node.

6. An apparatus for establishing non-access stratum (NAS) signalling in a wireless communication system, the apparatus comprising:
memory storing instructions; and
at least one processor, comprising processing circuitry, coupled to the memory ,
wherein the instructions, when executed by at least one processor individually and/or collectively, cause the apparatus to:
receive a request for connection establishment from a user equipment (UE), wherein the request comprises an indication for using NAS-over-internet protocol (IP);
assign an IP address to the UE based on the request; and
establish an IP connection, over a wireless communication channel, between the UE and a network-side interworking network function.

7. The apparatus as claimed in claim 6, wherein the instructions, when executed by at least one processor individually and/or collectively, cause the apparatus to:
transmit IP packets to the network-side interworking network function for delivery to a core-network function mobility management entity,
wherein the IP packets correspond to encapsulated one or more NAS messages using an internet-protocol based transport selected from a group including: transmission control protocol (TCP), hypertext transfer protocol (HTTP), and quick UDP internet connections (QUIC).

8. The apparatus as claimed in claim 7, wherein the instructions, when executed by at least one processor individually and/or collectively, cause the apparatus to:
transmit the IP packets to the network-side interworking network function until the IP connection between the UE and the network-side interworking network function is disconnected.

9. The apparatus as claimed in claim 6, wherein the network-side interworking network function is selected from a group including: a non-third generation partnership project (3GPP) interworking function (N3IWF), a trusted non-3GPP gateway function (TNGF), a user plane function (UPF) enhanced to anchor NAS signalling, and a new network function configured to process NAS messages over IP transport.

10. The apparatus as claimed in claim 6, wherein the IP address assigned by the RAN node is retained by the UE until another IP address is allocated by the RAN node.

11. One or more non-transitory computer-readable storage media storing one or more computer programs including computer-executable instructions that, when executed by one or more processors of an apparatus individually or collectively, cause the apparatus to perform operations, the operations comprising: receiving a request for connection establishment from a user equipment (UE), wherein the request comprises an indication for using non-access stratum (NAS)-over-internet protocol (IP);
assigning an IP address to the UE based on the request; and
establishing an IP connection between the UE and a network-side interworking network function, over a wireless communication channel.

12. The one or more non-transitory computer-readable storage media as claimed in claim 11, comprising:
transmitting IP packets to the network-side interworking network function for delivery to a core-network function mobility management entity,
wherein the IP packets correspond to encapsulated one or more NAS messages using an internet-protocol based transport selected from a group including: transmission control protocol (TCP), hypertext transfer protocol (HTTP), and quick UDP internet connections (QUIC).

13. The one or more non-transitory computer-readable storage media as claimed in claim 12, comprising:
transmitting the IP packets to the network-side interworking function until the IP connection between the UE and the network-side interworking network function is disconnected.

14. The one or more non-transitory computer-readable storage media as claimed in claim 11, wherein the network-side interworking network function is selected from a group including: a non-third generation partnership project (3GPP) interworking function (N3IWF), a trusted non-3GPP gateway function (TNGF), a user plane function (UPF) enhanced to anchor NAS signalling, and a new network function configured to process NAS messages over IP transport.

15. The one or more non-transitory computer-readable storage media as claimed in claim 11, wherein the IP address is retained by the UE until another IP address is allocated by the RAN node.
